(19) United States
(12) Patent Application Publication
(10) Pub. No.: US 2006/0151231 A1
(43) Pub. Date: Jul. 13, 2006

(54) Motor vehicle comprising a device for controlling the shifting movement of a closure element

(76) Inventors: Thomas Bucksch, Rottenburg (DE); Hermann Gaus, Stuttgart (DE); Peter Griesbach, Ostelsheim (DE); Uwe Gruner, Ebersbach (DE); Christoph Jung, Herrenberg (DE); Rainer Leucht, Baltmannsweiler (DE); Markus Riedel, Sulzburg (DE); Andreas Rodewald, Herrenberg (DE); Jurgen Zahn, Altensteig (DE)

Correspondence Address: FITCH, EVEN, TABIN & FLANNERY, P. O. BOX 65973, WASHINGTON, DC, 20035, US

(21) Appl. No.: 10/525,387

(22) PCT Filed: Aug. 16, 2003
(86) PCT No.: PCT/EP03/09092

§ 371 Date: Jul. 14, 2005

(30) Foreign Application Priority Data
Aug. 23, 2002 (DE) 10239546.2
Dec. 6, 2002 (DE) 19257033.7

(51) Int. Cl. B60K 17/00

(52) U.S. Cl. 180/337

(57) ABSTRACT

A motor vehicle contains a device (1) for controlling the shifting movement of a closure element by means of a shifting drive (5) fixed on the closure element. A transmission element (11) is mounted on a support console (7), which is connected fixedly to the closure element, which transmission element is movable relative to the support console (7), is mounted movably by a bearing region (13, 15) on a body region and is coupled by a coupling region (18), which faces away from the bearing region (13, 15), to the shifting drive (5) in order to transmit mechanical forces.

The invention relates to a motor vehicle having the features of the precharacterizing clause of claim 1.

It is known from DE 198 16 736 A1 to use a drive which operates electromechanically, pneumatically or hydraulically in order to shift a motor vehicle door. A specific configuration is not disclosed there.

DE 40 04 353 A1 discloses a driving mechanism for a window of a motor vehicle. In this driving mechanism, a window-opening motor drives a step-down gear and an opening mechanism. This mechanism may contain a parallel arm, a cross arm or a cable pull.

U.S. Pat. No. 4,530,185 discloses a motor vehicle having a device for shifting a closure element between an open position and a closed position. The shifting movement takes place by means of a shifting drive which is arranged on the vehicle door and has an electric motor and a movable kinematic chain which is arranged thereon and is coupled mechanically to a rod-like coupling element, which is connected movably to the body.

The invention is based on the object of providing an automatic shifting movement for closure elements, in which it is possible for the force transmission between the closure element and shifting drive to be highly efficient.

This object is achieved by the combination of features of claim 1.

According to the invention, the transmission element is additionally mounted movably on a support console connected fixedly to the closure element. The transmission element is movable relative to the support console. It is mounted movably with a bearing region on a body region (for example door frame, in particular A-pillar or B-pillar). A coupling region of the transmission element, which region faces away from the bearing region, is coupled mechanically to the shifting drive in order to transmit force.

Since, in the installed state, the shifting drive is fixed on the closure element (for example the housing of the shifting drive is connected fixedly to the closure element or the rotating spindle of the shifting drive is in a positionally fixed relative arrangement to the closure element) and the bearing region of the transmission element is mounted movably on a body region, when the shifting drive is activated the closure element is moved effectively, for example is shut, with comparatively low driving forces.

The transmission element is preferably produced as a rod, bar or the like. As a result, it assists a space-saving and mechanically stable construction of the device.

The support console is preferably produced as a separate component and designed in terms of structure in such a manner that it accommodates or supports the transmission element and, if appropriate, further functional elements. The support console, as a separate component, assists a modular construction of the device. This enables the entire device to be fitted on the closure element advantageously in an automated manner. As an alternative, the support console is already connected fixedly to the closure element before the transmission element and, if appropriate, further components are installed. In this case, the support console may be produced as a separate component or may be an integral part of the closure element.

The control device serves to control the movements of the closure element between a plurality of positions, in particular between an open position and a closed position. The control device contains mechanical, electromechanical and, if appropriate, also electronic components, such as control electronics, switching elements or other control means.

According to claim 2, transverse forces transverse to a translational movement between the transmission element and support console or closure element are possible, for example, as a result of which desired pivoting movements of a closure element between the open and closed position can be realized in a technically simple manner.

The measures of claims 3 to 6 support stable relative movements between the transmission element and closure element.

Claims 7 to 11 promote a space-saving construction of the force transmission mechanism.

A configuration of the cable-pull system with two cable pulls according to claims 12 to 15 contributes to the force transmission mechanism being in an equilibrium of forces if the shifting drive is not active in an intermediate position of the closure element. This in turn supports mechanically stable intermediate positions of the closure element.

Claim 16 proposes a suitable electric shifting drive. In this case, there is the possibility of using control signals to obtain an automated shifting movement of the closure element (when the electric motor and gear unit are coupled) or to achieve a manual opening or manual shutting of the closure element (when the electric motor and gear unit are decoupled). The corresponding control signals can be generated by actuation of a switch, button or the like. Control signals for the coupling may also be triggered by certain positions of the closure element. The coupling is preferably an electromagnetic coupling which can be triggered in a simple manner by control signals. The shifting drive is preferably activated/deactivated by the electric motor being switched on/off.

According to claim 18, the device can advantageously be produced as a kit or module which can then be electrically connected ready for operation in a simple manner via an interface. The interface is preferably part of an easy-to-install plug-in connection. In particular, this module is integrated into a closure element (for example a motor vehicle door) which can be connected via the interface to control electronics, for example a control unit, operating element or other control means. These means which are to be connected to the device can likewise be arranged within the closure element or on the closure element or positioned externally.

The closure element is preferably designed as a motor vehicle door, tailgate or trunk lid.

Claim 20 assists, without additional components, a high efficiency during the transformation of driving forces of the shifting drive into a pivoting movement of the vehicle door if the latter is to be shut.

Claim 25 permits a comfortable positioning of the closure element in any desired intermediate positions or an infinitely variable retention of the door. By this means, for example, an exact manual stopping of the motor vehicle door in a certain intermediate position or the careful positioning thereof in a parking gap is not required. In this case, the one extreme position corresponds, for example, to a door opening angle of approx. 15° while the other extreme position corresponds, for example, to a door end stop of approx. 85°. An infinitely variable retaining of the door is preferably not provided between the closed position and the extreme position facing it. This is then a working region without the retaining function, for example at opening angles of 0°-15° in the case of a vehicle door.

Claims 27 to 30 relate to advantageous measures for a suitable obstacle-recognition means or protection against pinching in an automated closing shifting movement of the closure element. In this case, the reversing path is preferably predetermined (for example 15° in the case of a pivotable closure element) before the shifting drive is deactivated. If the obstacle recognition takes place in a working region without the abovementioned retaining function, reversing is expediently carried out into a working region with the retaining function.

The invention is explained in more detail with reference to the exemplary embodiments illustrated in the drawings, in which:

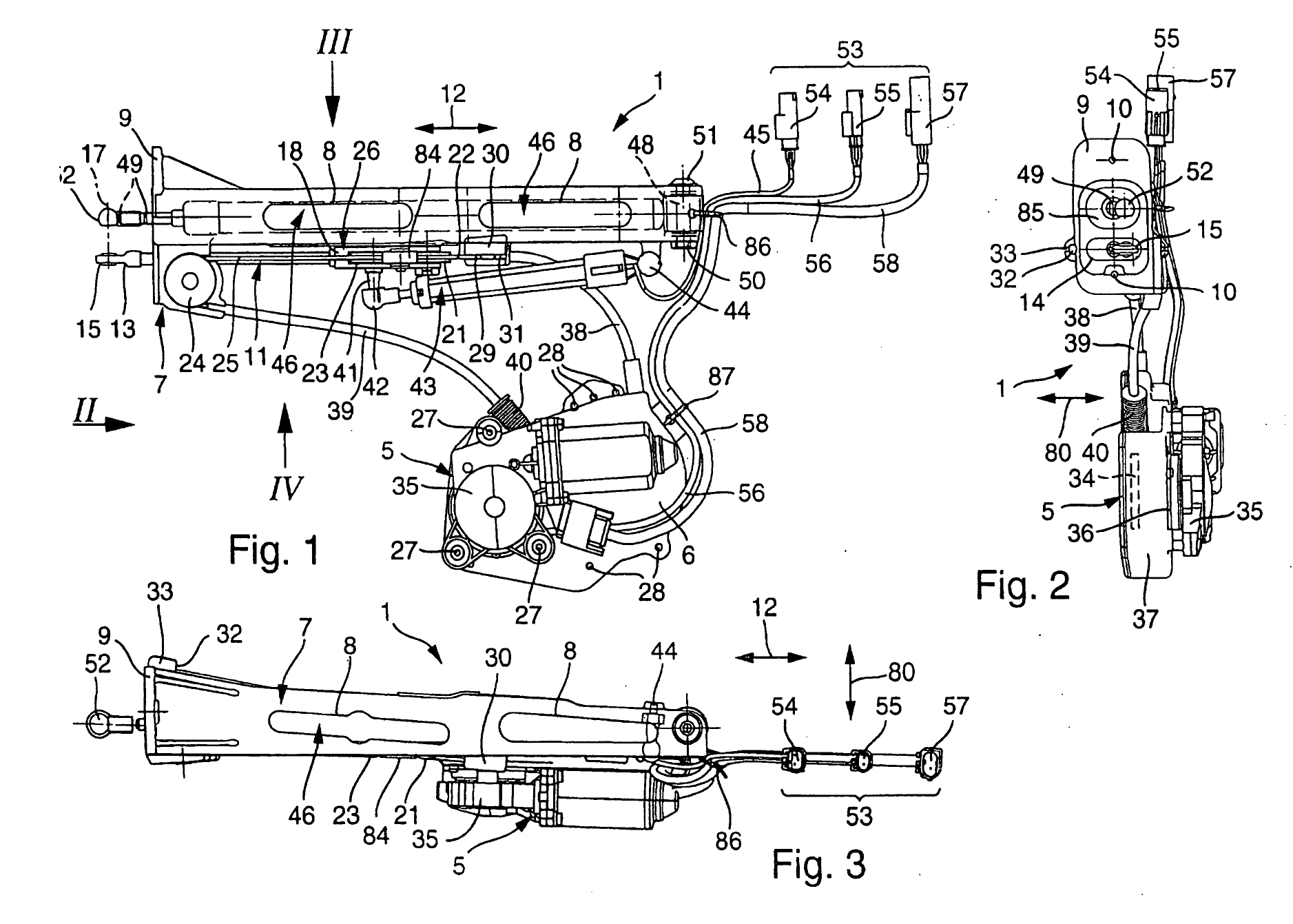

i. FIG. 1 shows a side view of the control device for controlling the shifting movement of a motor vehicle door,

ii. FIG. 2 shows a front view of the control device in the arrow direction II according to FIG. 1,

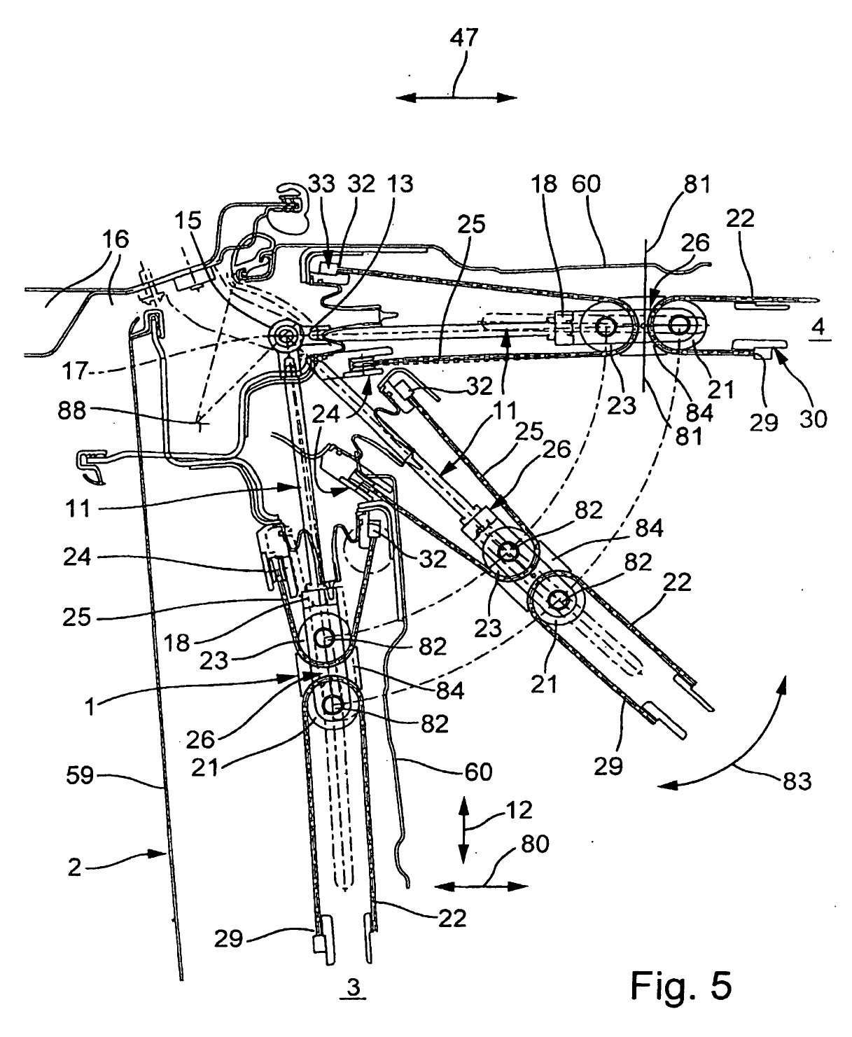

iii. FIG. 3 shows a plan view of the control device in the arrow direction III according to FIG. 1,

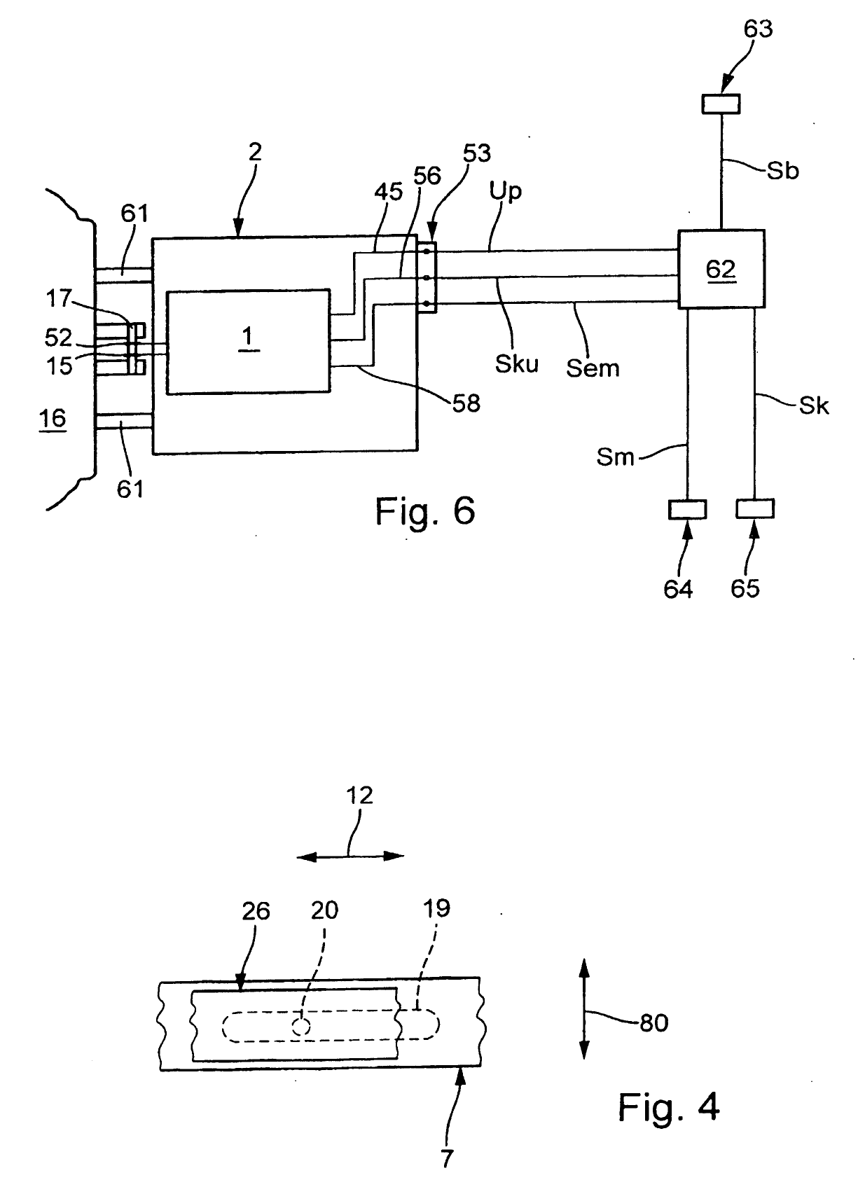

iv. FIG. 4 shows a schematic and partial plan view of the control device in the arrow direction IV according to FIG. 1,

v. FIG. 5 shows a schematic plan view of part of a motor vehicle door in various positions together with an illustration of the cable-pull system,

vi. FIG. 6 shows a block circuit diagram with a schematic illustration of the motor vehicle door, of a body region adjacent thereto and of control electronics for triggering the control device,

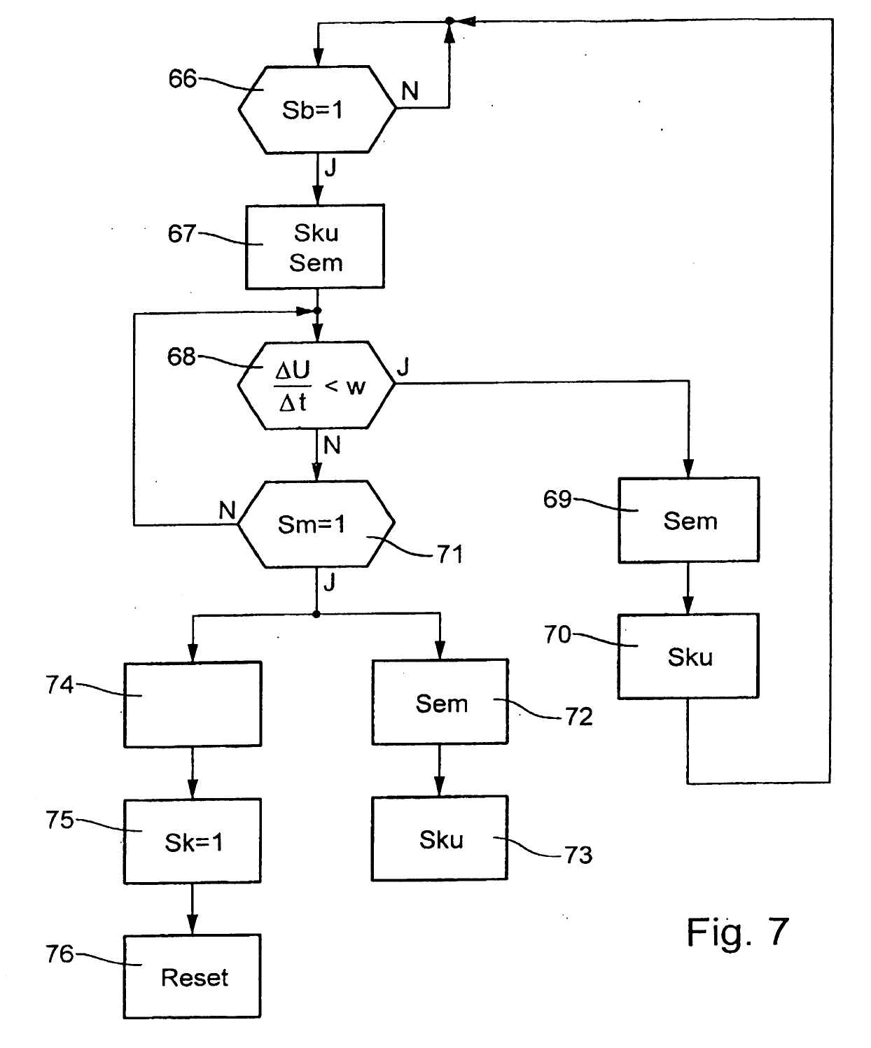

vii. FIG. 7 shows a flow diagram containing the functioning of the control device during the automatic shutting of a motor vehicle door.

The control device 1 according to FIG. 1 serves to control shifting movements of a motor vehicle door—door 2 for short below—between an open position 3 and a closed position 4. The control device 1 contains, inter alia, a shifting drive 5, the drive housing 6 of which is fastened in a manner not illustrated specifically to the door 2. The housing screws 27 and/or screws for the housing holes 28 and/or other suitable fastening means can be used for the fastening.

The control device 1 has a support console 7 with a plurality of slot-like console perforations 8 which advantageously reduce the dead weight of the support console 7. In the installed state, the support console 7 is integrated in the door 2 and serves for mounting and fixing a plurality of components (which still have to be described) of the control device 1. Components of the control device 1 are mounted and fixed on the door 2 in the required manner by means of the support console 7. A plate-like front region 9 of the support console 7 has two screw holes 10 passing through it, said screw holes corresponding with corresponding fastening screws in order to connect the support console 7 fixedly to the door 2.

A transmission element 11 which is of rod- or bar-like design is mounted on the support console 7. It is mounted movably relative to the support console 7, and therefore also relative to the door 2. In a longitudinal direction 12 of the support console 7, the transmission element 11 projects by means of a bearing free end 13 beyond the support console 7 through a first front opening 14 of the front region 9. The slot-like front opening 14 permits the transmission element 11 to be movable in a transverse direction 80. The bearing free end 13 has an articulated opening 15 through which a rotating spindle 17, which is fastened to a door frame 16 or to a vehicle pillar (for example A-pillar or B-pillar) of the motor vehicle body, is passed. The transmission element 11 is thereby mounted rotatably on a frame of the body that surrounds the door 2 in the closed position 4. By means of a coupling region 18 which faces away from the bearing free end 13, the transmission element 11 is coupled to the shifting drive 5 in order to transmit mechanical forces between the transmission element 11 and shifting drive 5.

For defined sequences of movement between the support console 7 and transmission element 11, a movement guide in the form of a slotted-guide mechanism is provided between these parts. In this case, the support console 7 has a slotted-guide track or guide track 19 while the transmission element 11 bears a guide pin 20 engaging in this guide track 19 (FIG. 4). In this case, the slotted-guide mechanism is designed in such a manner that the transmission element 11 and the support console are movable relative to each other in a plane of movement which is defined by the longitudinal direction 12 and the transverse direction 80.

The force transmission between the transmission element 11 and shifting drive 5 takes place by means of a cable-pull system which is connected in terms of force, on the one hand, to the coupling region 18 of the transmission element 11 and, on the other hand, to the shifting drive 5. The cable-pull system contains a first return pulley 21 for a first pulling cable 22 and a second return pulley 23 and a third return pulley 24 for a second pulling cable 25. The return pulleys 21, 23 are fixed on a pulley holder 26. The pulley holder 26 is connected fixedly in the coupling region 18 of the transmission element 11. The pulley holder 26 also bears the guide pin 20.

The first pulling cable 22 is fixed by a first cable end 29 on a fixing section 30 of the support console 7. For this purpose, the cable end 29, which has been strengthened in comparison to the pulling cable 22, is inserted into a first fixing groove 31 and, as a consequence of the geometrical dimensioning of the fixing groove 31 in the pulling direction, is secured against dropping out of the fixing groove 31. The same applies to the second pulling cable 25 which is fixed by a first cable end 32 in a second fixing groove 33 of the support console 7. The second cable ends of the pulling cables 22, 25 are each connected to a cable drum 34 which is mounted rotatably in the drive housing 6 of the gear unit 5. The pulling cables 22, 29 are connected to the cable drum 34 in such a manner that, during the movement of the door 2, either the first pulling cable 22 is wound up on the cable drum 34 and the second pulling cable 25 is unwound on the cable drum 34, or conversely, the first pulling cable 22 is unwound and the second pulling cable 25 is wound up. The two cable pulls 22, 25 are each surrounded by a protective sheath 38, 39 in which the corresponding pulling cable 22 or 25 can move freely. A spring element 40 in the form of a tension spring is arranged on that section of the second pulling cable 25 which is adjacent to the drive housing 6. Said tension spring is operatively connected in a manner not illustrated specifically to the pulling cables 22, 25 in such a manner that a stretching behavior of the pulling cables 22, 25 over the course of the operating time and a possible slack in the cable-pull system are compensated for. In addition, the spring element 40 contributes to the pulling cables 22, 25 transmitting the forces at a defined tension.

The first cable ends 29, 32 are arranged with respect to an imaginary separating line 81 (illustrated in FIG. 5 in the closed position 4), which separates the two return pulleys 21, 23 from each other, on two opposite sides of this separating line 81, i.e. the first cable end 32 is arranged on the left side and the first cable end 29 is arranged on the right side of this separating line 81. At the same time, the two first cable ends 29, 32 are arranged diagonally opposite with respect to the transmission element 11. The two return pulleys 21, 23 are spaced apart from each other in the longitudinal direction 12. In this case, their central longitudinal axes 82, which run perpendicularly with respect to the plane of the drawing page, are arranged parallel to each other and the return pulleys 21, 23 are situated approximately in the same plane.

During the automatic shutting of the door 2 along the pivoting direction 83 toward the closed position 4, the first cable 22 is wound up on the cable drum 34. As a result, the door 2 is moved automatically relative to the transmission element 11 and is drawn closer to the rotating spindle 17. Owing to the configuration of the guide track 19, transverse forces can act on the support console 7 or on the door 2, so that a pivoting movement of the door 2 toward the closed position 4 is automatically assisted. In the closed position 4, a larger portion of the first pulling cable 22 is consequently wound up than in the open position 3 (FIG. 5). For the second pulling cable 25, this sequence is precisely reversed, since said pulling cable is correspondingly fixed on the cable drum 34.

The pulley holder 26 bears a guide element 84, which is of biconcave design in cross section, is arranged between the two return pulleys 21, 23 and assists a movement guidance of the pulling cables 22, 25.

The shifting drive 5 has an electric motor 35 which can be coupled to a gear unit 37 and can be decoupled from the gear unit 37 via a coupling 36. The coupling 36 can be triggered via control means (yet to be described in detail) or control electronics in order to obtain the coupling and decoupling.

On its side facing the shifting drive 5, the pulley holder 26 bears a fixing spike 41. The latter engages in a half-shell-like mount 42 of a linear potentiometer—for short below: potentiometer 43. A fastening end 44 which lies opposite the mount 42 in the longitudinal direction of the potentiometer 43 and is in the form of a ball-ended pin is fastened to the support console 7. The potentiometer 43 is thereby connected mechanically, on the one hand, to the transmission element 11 and, on the other hand, to the door 2. An electric voltage Up which is dependent on the position of the door 2 can be tapped off across the potentiometer 43 via a first cable 45.

The control device 1 has means 46 for arresting the door 2 in any desired intermediate positions between a first and a second extreme position. The extreme positions do not have to coincide with the open position 3 and with the closed position 4. In the closed position 4, the door 2 runs approximately in the vehicle longitudinal direction 47 (FIG. 5). The arresting means 46 are designed as an essentially cylindrical component with a first articulated end 48 and a second articulated end 49 lying opposite the longitudinal direction 12. The first articulated end 48 is mounted rotatably by means of a console screw 50 and a corresponding screw nut 51 on the support console 7 and therefore on the door 2. In this case, the rotating spindle runs approximately parallel to the rotating spindle 17 of the transmission element 11. The second articulated end 48 bears an articulated head 52 which, in the installed state, is mounted rotatably on a rotating spindle. This rotating spindle preferably runs parallel to the rotating spindle 17 and is likewise fastened to the door frame 16 or to another body region. In particular, the articulated head 52 is also mounted on the rotating spindle 17 (FIG. 6). The second articulated end 49 is surrounded at a distance by a slot-like console opening 85. It can be sealed off by a collar surrounding the articulated end 49. The console opening 85 permits mobility between the support console 7 and arresting means 46.

The arresting means 46 contain a piston with a piston rod which is movable along the longitudinal direction 12 in a hydraulic cylinder. Spring-pressure-actuated valves in the piston assembly mean that the hydraulic oil can only flow in a retarded manner in both movement directions along the longitudinal direction 12. In order to overcome the retaining force which retains the door 2 in a position, the appropriate valve or a plurality of valves first of all have to be opened by the build up of pressure. As soon as the valve opens, a relatively large cross section is freed, so that the hydraulic fluid can flow with little force from one side of the piston to the other side along the longitudinal direction 12. As soon as the flow velocity is reduced again to zero by the door stopping (manually or automatically), the valve or the valves close again on account of the spring-pressure force. In this case, the first articulated end 48 is preferably connected fixedly to the piston rod while the second articulated end 49 is fastened to the hydraulic cylinder. Starting from an intermediate position of the door 2 until the open position 3 is reached, it is also possible for an end position damping to be provided in the locking means, by means of which the movement of the door 2 is braked immediately before the open position 3 is reached.

The control device 1 has an electrical interface 53 for electrical connections. The interface 53 is designed as a plug-in connection and contains three plugs. A first plug 54 is assigned to the first cable 45. A second plug 55 is assigned to a second cable 56. The coupling 36 is triggered via this cable 56. A third plug 57 is assigned to a third cable 58. The electric motor 35 is triggered and supplied via this third cable 58. The cables are secured mechanically on the support console 7 and on the drive housing 6 by means of cable binders 86, 87. The control device 1 according to FIG. 1 to FIG. 3 forms, to a certain extent, a module which can be fitted at a suitable location in the motor vehicle and for operation can be connected via the interface 53 to external control electronics, control units or other control means. According to FIG. 5, the control device 1 is integrated into the door 2 in a cavity between the outer paneling 59 thereof and an inner side 60 which faces the vehicle interior.

FIG. 6 schematically illustrates the coupling of the door 2 and of the control device 1 to the vehicle body, namely to the door frame 16. The rotating spindle 17 is fastened to the door frame 16. The door 2 is mounted pivotably on the door frame 16 by means of the hinges 61. In FIG. 5, the hinges 61 are symbolized by a pivot axis 88. The control device 1 is integrated in the door 2 and wired up to control means via the interface 53. The control means have a control unit 62 which is arranged in the motor vehicle within or outside the door 2. An actuating element 63 for the manual triggering of the electric shutting of the door is connected to the control unit 62. The actuating element 63 is preferably designed as a switch or button and is arranged, for example, in the roof-operating unit of the motor vehicle.

The automatic shutting of the door is explained with reference to FIG. 6. As already mentioned, this shutting of the door is initiated by actuation of the actuating element 63. It is therefore checked in an interrogation step 66 whether the switching state of the actuating element 63 has been set to “1”. In this case, the control unit 62 receives a corresponding signal Sb=1. Then, in a step 67, the control unit 62 triggers the shifting drive 5 in order to switch it on. In this case, the control unit 62 first of all supplies the coupling 36 with a control signal Sku in order to obtain a frictional connection or coupling between the electric motor 35 and gear unit 37, since in the initial state—i.e. when the door 2 is not being moved—the electric motor 35 and the gear unit 37 are decoupled. The electric motor 35 is then triggered by a control signal Sem in order to energize it.

In a next interrogation step 68, the voltage Up which has been tapped off across the potentiometer 43 is evaluated in the control unit 62. In this case, a voltage value corresponds to a certain position of the door 2. A defined time interval Δt passes between two consecutive voltages values, which can be represented by their voltage difference ΔU. If the voltage difference ΔU in the defined time interval Δt is too small, the door 2 has covered too small a distance. The quotient ΔU/Δt drops below a threshold value w. This is interpreted as an obstacle. As an alternative, an obstacle recognition can also take place by a time interval between two consecutive voltage signals being determined and being compared with a time interval predetermined for this.

As soon as an obstacle has been recognized, the control unit 62 triggers the shifting drive 5 in a step 69. The electric motor 35 is either switched off or first of all reversed and then switched off. Then, in a step 70, the control unit 62 supplies the coupling 36 with a corresponding signal Sku in order to cancel the frictional connection between the electric motor 35 and gear unit 37. A continuation of the closing process is possible by the actuating element 63 being actuated again.

During the automatic closing process, the shifting drive 5—if an obstacle is not registered—can remain activated until the closed position 4, in which the door 2 is completely shut, is reached. The shifting drive 5 is then deactivated by corresponding control signals Sem and Sku at the electric motor 35 and gear unit 37 (steps 72, 73).

As an alternative, directly before the closed position is reached, the closing process may proceed as follows: from a certain engagement position (there may be a plurality of engagement positions) of the door lock (e.g. lock/rotary latch in the door 2 and corresponding locking bracket in the door frame), in which the door 2 has not yet been shut completely into the closed position 4, an automatic closing aid, in particular servoclosing, can be activated. For this purpose, the control device 1 is supplemented by switching elements which interact with the control electronics or the control unit 62. A switching element in the form of a microswitch 64 is arranged in the lock part assigned to the door 2 and is likewise connected to the control means, in particular the control unit 62. It registers the certain engagement position mentioned above. The triggering of the closing aid for the final shutting of the door 2 into the door frame or into the lock of the door frame is dependent on the switching state of said switching element. The switching state of a control switch 65, preferably a door contact switch, changes as soon as the closed position 4 is reached. In this case, the closing aid is deactivated, in particular by means of the changed switching state of the control switch 65.

In a step 71, the control unit 62 interrogates the switching state Sm of the microswitch 64. For example, let it be assumed that the switching state Sm=0 when the door 2 is open and is switched over to Sm=1 when the lock parts come into the abovementioned certain engagement position. The interrogation steps 68 and 71 can take place successively in time or in parallel. If the switching state Sm=1 is registered, the control unit 62 uses a corresponding control signal Sem to switch off the electric motor 35 (step 72) and then uses a corresponding control signal Sku sent to the coupling 36 to decouple the electric motor 35 and the gear unit 37 from each other (step 73). In addition, the switching state Sm=1 can be used to deactivate the obstacle-recognition means or the means for protecting against pinching. In addition, when the switching state Sm=1 is registered, the closing aid is automatically activated (step 74) in order to finally shut the door 2. The control switch 65 is switched over when the door 2 has finally been shut. If the switching state Sk=0 is assumed before the final shutting of the door 2, the control switch 65 obtains the switching state Sk=1 when the door 2 is finally shut (step 75). The control means or the control unit 62 registers the new switching state Sk and can reset themselves and/or, if appropriate, further control means into a reset state (step 76).

It should be mentioned that the use of the described, automatic closing process and/or of the closing aid for finally shutting the door 2 is not restricted to this door 2 as closure element. On the contrary, these components and sequences of movement can be used on all types of closure elements—even outside the vehicle sector. Also, the control means and switching elements do not necessarily have to be electric components; it is also possible in part or entirely for optical components or other technologies for switching, controlling, activating and deactivating to be provided.

Since, in the closed position of the door 2, the electric motor 35 and gear unit 37 are decoupled from each other, the door 2 can be opened manually without unnecessary effort.

In addition, an automatic, electric opening of the door 2 from the closed position 4 can take place by actuation of the actuating element 63. After this actuation and a release of the door 2 by corresponding unlocking of the door lock, in principle step 67 and a suitable evaluation and processing of the voltage which can be tapped off across the potentiometer 43 can take place until a defined open position is reached. In this open position, step 72 and step 73 can then be automatically triggered.

It should be pointed out that the dimensions illustrated in the drawings for individual components are not necessarily to scale.

1. A motor vehicle comprising a device (1) for controlling the shifting movement of a closure element (2) between an open position (3) and closed position (4) by means of a shifting drive (5) fixed on the closure element (2), which shifting drive, in an activated state, automatically adjusts the closure element (2), a transmission element (11) being provided which
is mounted movably with a bearing region (13, 15) on a body region (16), and
is coupled by a coupling region (18), which faces away from the bearing region (13, 15), to the shifting drive (5) in order to transmit mechanical forces,
characterized
in that the transmission element (11) is additionally mounted movably on a support console (7) connected fixedly to the closure element (2).

2. The motor vehicle as claimed in claim 1,
characterized
in that the transmission element (11) is movable in different directions (12, 80) relative to the support console (7).

3. The motor vehicle as claimed in claim 1,
characterized by
a movement guide between the transmission element (11) and support console (7).

4. The motor vehicle as claimed in claim 3,
characterized
in that the transmission element (11) and the support console (7) are connected movably to each other via a slotted-guide mechanism.

5. The motor vehicle as claimed in claim 4,
characterized
in that the support console (7) has a guide track (19), and
in that the transmission element (11) has a guide pin (20) corresponding with the guide track (19).

6. The motor vehicle as claimed in claim 1,
characterized
in that the bearing region (13, 15) of the transmission element (11) is mounted on a rotary bearing (17) of the body.

7. The motor vehicle as claimed in claim 1,
characterized
in that it has a cable-pull system (22, 29) which is operatively connected, on the one hand, to the coupling region (18) of the transmission element (11) and, on the other hand, to the shifting drive (5).

8. The motor vehicle as claimed in claim 7,
characterized
in that the cable-pull system (22, 25) contains at least one return pulley (21, 23) for at least one pulling cable (22, 25).

9. The motor vehicle as claimed in claim 8,
characterized
in that one return pulley (21, 23) is fixed on the coupling region (18) of the transmission element (11).

10. The motor vehicle as claimed in claim 8,
characterized
in that a first pulling cable (22)
is fixed by a first cable end (29) to a fixing section (30) of the support console (7) and
is operatively connected by a second cable end to the shifting drive (5).

11. The motor vehicle as claimed in claim 10,
characterized
in that the shifting drive (5) is coupled to a cable drum (34) to which the second cable end of the first pulling cable (22) is connected.

12. The motor vehicle as claimed in claim 8,
characterized
in that at least two return pulleys (21, 23, 24) are provided,
the first return pulley (21) being assigned to the first pulling cable (22) and a second return pulley (23) being assigned to a second pulling cable (25),
the two return pulleys (21, 23) being fixed on the coupling region (18) of the transmission element (11) at a distance from each other in a movement direction (12) of the transmission element (11).

13. The motor vehicle as claimed in claim 12,
characterized
in that the second pulling cable (25) is fixed by a first cable end (32) on a fixing section (33) of the support console (7) and is operatively connected by a second cable end to the shifting drive (5).

14. The motor vehicle as claimed in claim 13,
characterized
in that the first pulling cable (22)
is fixed by the first cable end (29) to a fixing section (30) of the support console (7) and
is operatively connected by a second cable end to the shifting drive (5); and,
the two fixing sections (30, 33) are arranged with respect to an imaginary separating line (81), which separates the two return pulleys (21, 23) from each other, on two opposite sides of this separating line (81).

15. The motor vehicle as claimed in one of claim 13,
characterized
in that the two cable ends of the two pulling cables (22, 25) are connected to the cable drum (34) in such a manner that, when the cable drum (34) is moved, either the first pulling cable (22) is wound up and the second pulling cable (25) is unwound, or vice versa.

16. The motor vehicle as claimed in claim 1,
characterized
in that the shifting drive (5) has an electric motor (35) which can be coupled to a gear unit (37) and can be decoupled from the gear unit (37) via a coupling (36).

17. The motor vehicle as claimed in claim 1,
characterized
in that it has an electrical interface (53) for an electrical connection.

18. The motor vehicle as claimed in claim 1,
characterized
in that the control device (1) is at least partially mounted onto the closure element (2), in particular is fitted into the closure element (2).

19. The motor vehicle as claimed in claim 1,
characterized
in that the closure element is designed as a motor vehicle door (2).

20. The motor vehicle as claimed in claim 19,
characterized
in that the motor vehicle door (2) is inclined with respect to a vertical plane in the direction of the vehicle interior.

21. The motor vehicle as claimed in claim 16,
characterized
in that the coupling (36) can be triggered for coupling and decoupling purposes via control means (62).

22. The motor vehicle as claimed in claim 21,
wherein the triggering takes place in such a manner that the electric motor (35) and the gear unit (37) are decoupled when the closure element (2) is not being moved and/or when the electric motor (35) is deactivated.

23. The motor vehicle as claimed in claim 21,
characterized
in that the triggering takes place in such a manner that the electric motor (35) and the gear unit (37) are coupled when the electric motor (35) is activated.

24. The motor vehicle as claimed in claim 1,
characterized
in that the shifting drive (5)
can be activated via an actuating element (63) and
can be triggered in such a manner that it remains deactivated during the shifting of the closure element (2) out of the closed position (4).

25. The motor vehicle as claimed in claim 1,
characterized
in that means (46) for arresting the closure element (2) in any desired intermediate positions between a first and a second extreme position are provided.

26. The motor vehicle as claimed in claim 1,
characterized
in that an obstacle-recognition means is provided which, when an obstacle is recognized during the closing shifting movement, supplies the shifting drive (5) with a control signal (Sem) for deactivating or reversing the shifting drive (5).

27. The motor vehicle as claimed in claim 26,
characterized
in that a physical variable (Up) which is dependent on the position of the closure element (2) is evaluated for obstacle-recognition purposes.

28. The motor vehicle as claimed in claim 27,
characterized
in that a variable ohmic resistor (43) is mechanically connected to the closure element (2) in such a manner that a position-dependent, electric voltage (Up) can be tapped off across the resistor (43).

29. The motor vehicle as claimed in claim 26,
characterized
in that the triggering of the control signal (Sem) is dependent on the comparison of two consecutive voltage values (ΔU) with a threshold value (w).

30. The motor vehicle as claimed in claim 29,
characterized
in that a quotient is formed from two consecutive voltage values (ΔU) and a predetermined time interval (Δt) for comparison with the threshold value (w)
